(19) United States
(12) Patent Application Publication
(10) Pub. No.: US 2006/0013627 A1
(43) Pub. Date: Jan. 19, 2006

(54) Automatic document feeder and an image forming apparatus having the same

(75) Inventor: Dong-ha Choi, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/146,099

(22) Filed: Jun. 7, 2005

(30) Foreign Application Priority Data
Jul. 19, 2004 (KR) 2004-55941

(51) Int. Cl. G03G 15/00

(52) U.S. Cl. 399/367

(57) ABSTRACT

An automatic document feeder (ADF) for an image forming apparatus has a feeding roller to supply stacked document sheets. A transfer roller moves the supplied documents. A white bar is disposed above the ADF glass to bring the document into tight contact with the ADF glass. A controlling member is mounted on a document path to restrain vertical fluctuation of the document entering under the white bar. Accordingly, a document path does not change before and after the document passes through a scanning position. Thus, a front part and a rear part of the document are transferred at the same speed, thereby resulting in improved quality of copied and scanned images.

### CROSS-REFERENCE TO RELATED APPLICATIONS

This application claims the benefit of Korean Patent Application No. 2004-55941, filed Jul. 19, 2004, in the Korean Intellectual Property Office, the entire disclosure of which is hereby incorporated by reference.

### BACKGROUND OF THE INVENTION

1. Field of the Invention

The present invention relates to an automatic document feeder (ADF) and an image forming apparatus having the same.

2. Description of the Related Art

Image forming apparatuses, such as digital photocopy machines, multi-function peripherals (MFP) and scanners, are able to scan and store documents, and are further able to print or transmit stored documents. A conventional multi-function peripheral (MFP) is schematically illustrated in FIG. 1 as an example of the image forming apparatuses.

As shown in FIG. 1, an image forming apparatus 50 includes a cover 10 and a main body 30. The cover 10 has an automatic document feeder (ADF) 20, and the main body 30 has a reader part 40 for reading a document supplied by the ADF 20.

The ADF 20 has a document path P generally formed in a substantial C-shape. The document stacked on a document tray 21 is guided to the reader part 40, passing through a pickup roller 22, a transfer roller 23 and a feeding roller 24. After being read by the reader part 40, the document is discharged by a discharging roller 25.

FIG. 2 is an enlarged view of a portion G of FIG. 1. An ADF glass 27 is mounted on an upper part of the reader part 40 to support the document. A reference number ‘A’ denotes a position for scanning the document. A white bar 26 is urged toward the ADF glass 27 by resilient member 28 while maintaining a regular distance ‘g’ from the ADF glass 27, thereby tightly contacting the document with the ADF glass 27.

The document supplied by the feeding roller 24 (FIG. 1) is transferred along a first path P1 (illustrated as a solid line), scanned at the scanning position ‘A’ by the reader part 40 (FIG. 1), and then discharged by passing through the white bar 26. However, as the document passes through the white bar 26 to be discharged, a leading end E of the document touches a slope 34 of an ADF glass frame 32, and this temporarily stops movement of the leading end E due to friction by the slope 34. However, since the feeding roller 24 (FIG. 1) keeps the operation of transferring the document in a moving direction of the first path P1, a rear part R of the document droops along a second path P2 illustrated by a dotted line.

Due to the droop of the document, speed of the document is decreased when the rear part R thereof, which is located near a white bar entrance 37, passes through the scanning position ‘A’ compared to when a front part F of the document passes through the scanning position ‘A’. More specifically, the front part F of the document enters the white bar 26 through the path P1 and passes through the scanning position ‘A’. Here, when the leading end E of the document touches the slope 34, the rear part R which has not yet passed through the scanning position ‘A’ advances along the second path P2. Therefore, as shown in FIG. 3, a distance d2 for the rear part R of the document to pass through from the white bar entrance 37 to the scanning position ‘A’ becomes longer than a distance d1 for the front part F of the document to perform the same.

As can be appreciated from the above, while the scanning position ‘A’ and scanning speed of the reader part 40 at the scanning position ‘A’ are regular, the distance of the path for transferring the document is increased at the rear part R, compared to at the front part F, as the document passes by. Accordingly, the speed of the rear part R passing through the scanning position ‘A’ is reduced, compared to that of the front part F.

FIG. 4 illustrates a document, as copied, passing through the scanning position ‘A’. Horizontal lines are scales uniformly dividing by 1 mm a printed letter ‘f’ of the document before being scanned. As shown in FIG. 4, the printed letter is uniformly read at the front part F, however, intervals between the horizontal lines are enlarged at the rear part R due to the reduced speed. According to the above, the quality of copied or scanned images in the conventional ADF is inferior.

Accordingly, a need exists for an image forming apparatus having an automatic document feeder that controls the speed of a document passing therethrough to improved the quality of copied and scanned images.

### SUMMARY OF THE INVENTION

An object of the present invention is to provide an automatic document feeder (ADF) capable of controlling the speed of a document passing through a scanning position to be substantially constant, and an image forming apparatus having the same.

An ADF mounted above a reader part that reads a document automatically supplies the document to an ADF glass that supports the document. The ADF includes a pickup roller for supplying stacked documents. A transfer roller transfers the picked-up document. A feeding roller arranges and supplies the transferred document. A white bar is disposed above the ADF glass to bring the document into tight contact with the ADF glass. A controlling member is mounted on a document path to restrain vertical fluctuation of the document entering under the white bar.

The controlling member is implemented by at least one roller mounted at an upper stream of the white bar of the document path.

The roller is preferably integrally formed with the white bar.

At least one of the rollers is mounted in a length direction of the white bar, and idly rotates on a rotation shaft thereof.

The white bar is substantially U-shaped and has a bottom and two sides. The rotation shaft of the roller is connected to a fixing member fixed at one side of the white bar.

The roller is formed by enclosing a sponge on the rotation shaft.

A distance D4 between the ADF glass and the roller is smaller than a distance D3 between the ADF glass and a bottom of the white bar.

A distance D2 refers to a width of a white bar entrance that is a pathway for the document to enter the white bar. A distance D1 refers to a width of a white bar exit that is a pathway for the document to exit the white bar. The distances D1, D2 and D3 satisfy the relationship D3<D2<D1.

An image forming apparatus with a cover including an ADF having a document tray for stacking documents thereon, and a main body including at an upper part thereof a flat glass for leaf-scanning. An ADF glass continuously scans the documents supplied from the ADF. A reader part is mounted under the flat glass and the ADF glass. The ADF includes a pickup roller for supplying stacked documents. A transfer roller transfers picked-up documents. A feeding roller arranges and supplies the transferred documents. A white bar is disposed above the ADF glass to bring the documents into tight contact with the ADF glass. A controlling member is mounted on a document path to restrain vertical fluctuation of the documents entering under the white bar.

Other objects, advantages and salient features of the invention will become apparent from the following detailed description, which, taken in conjunction with the annexed drawings, discloses preferred embodiments of the invention.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a schematic sectional view of a conventional image forming apparatus;

FIG. 2 is an enlarged view of a portion G of FIG. 1;

FIG. 3 shows a moving path of a printing paper through the apparatus of FIG. 2;

FIG. 4 is a view of a document read by a conventional art;

FIG. 5 is a perspective view of an image forming apparatus according to an embodiment of the present invention;

FIG. 6 is a sectional view of an automatic document feeder according to an embodiment of the present invention;

FIG. 7 is an enlarged sectional view of the ADF of FIG. 6;

FIG. 8 is a graphical representation of the speed of a document passing through a scanning position; and

FIG. 9 is a view showing a document read according to an embodiment of the present invention.

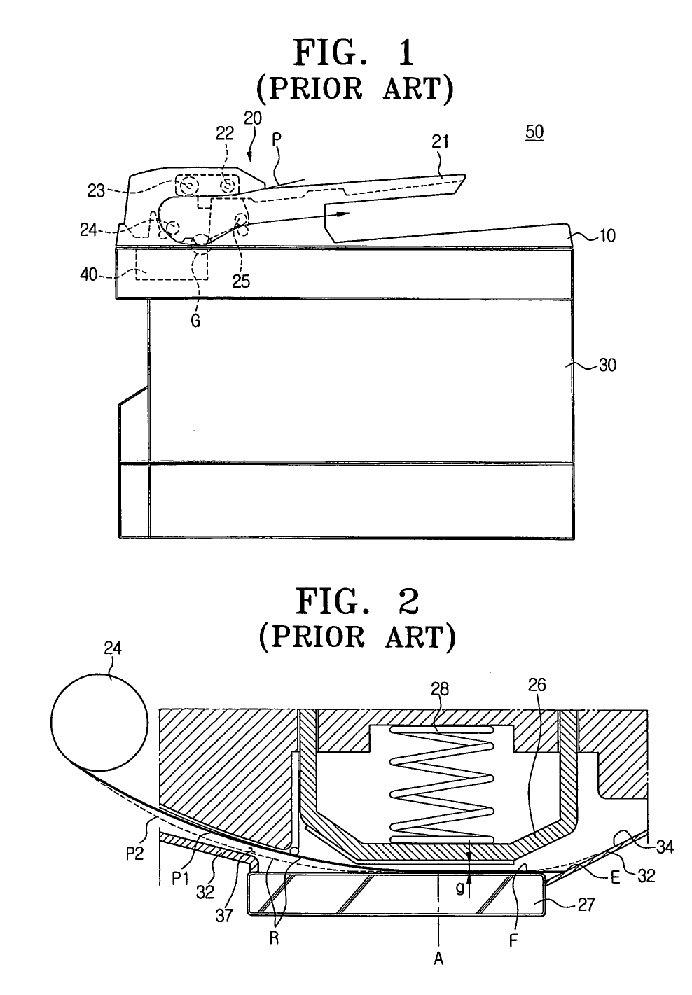

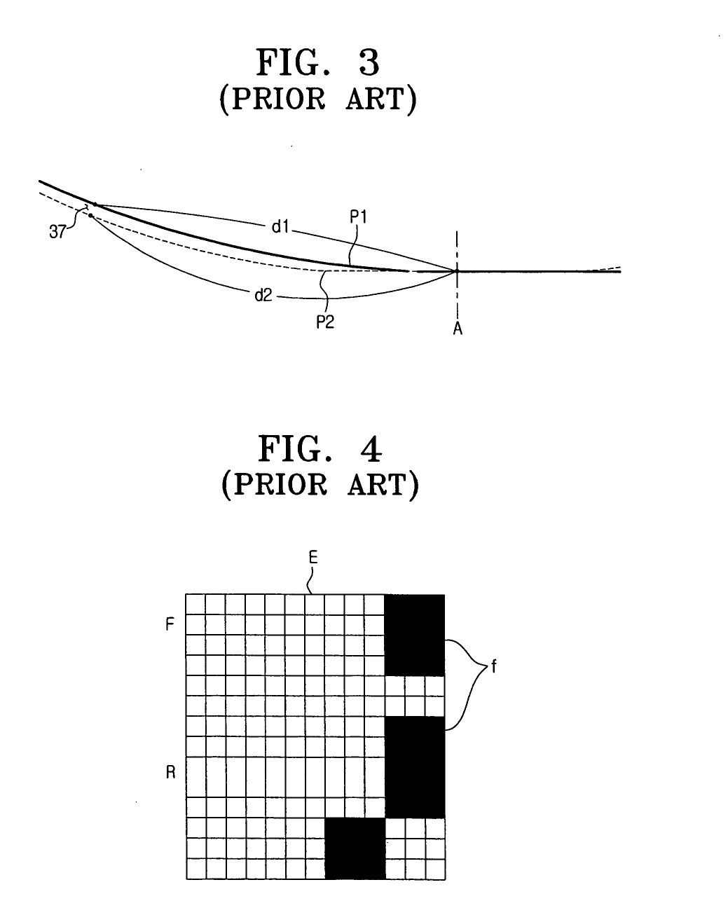

Throughout the drawings, like reference numerals will be understood to refer to like parts, components and structures.

### DETAILED DESCRIPTION OF EXEMPLARY EMBODIMENTS

Hereinafter, certain embodiments of the present invention will be described in detail with reference to the accompanying drawing figures.

The matters defined in the description, such as a detailed construction and elements thereof, are provided to assist in a comprehensive understanding of the invention. Thus, it is apparent that the present invention may be carried out without those defined matters. Also, well-known functions or constructions are not described in detail to provide a clear and concise description.

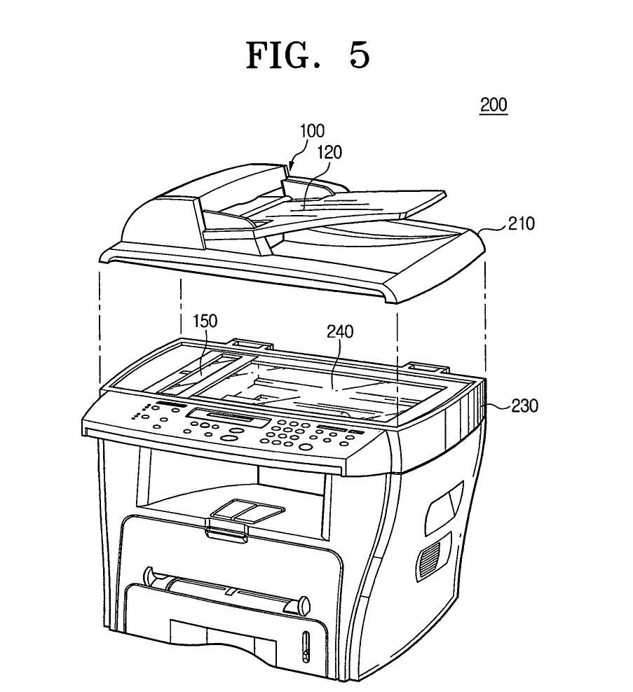

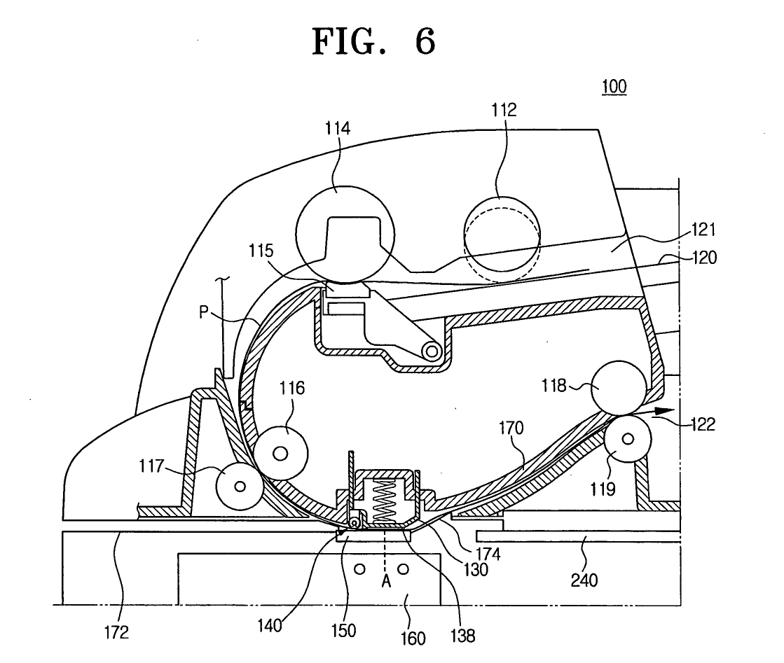

Referring to FIG. 5, an image forming apparatus according to an exemplary embodiment of the present invention includes a cover 210 and a main body 230. The cover 210 has an automatic document feeder (ADF) 100 including a document tray 120. The main body 230 has, at an upper part thereof, an ADF glass 150 for continuous scanning and a flat glass 240 for leaf-scanning. A reader part 160 (FIG. 6) for reading a document is mounted under the ADF glass 150 and the flat glass 240. When performing the leaf-scanning, the reader part 160 scans the document that is moved along and put on the flat glass 240. For the continuous scanning, the reader part 160 scans the document that is transferred by the ADF 100 mounted to the cover 210 and put on the ADF glass 150.

Referring to FIG. 6, a document inlet 121 and a document outlet 122 are disposed above and below in the ADF 100 to direct documents in the same direction. A document path P is formed as an open curve of a substantial C-shape and connects the document inlet 121 and the document outlet 122.

The ADF 100 includes a pickup roller 112, a transfer roller 114, a feeding roller 116 and a discharge roller 118, which are sequentially disposed along the document path P between the document inlet 121 and the document outlet 122. First and second backup rollers 117 and 119 idly rotate, and are mounted at positions proximal the feeding roller 116 and the discharge roller 118, respectively.

The pickup roller 112 picks up a document stacked on the document tray 120 and supplies the document to the document path P. A dotted line illustrates a position of the pickup roller 112 when the pickup roller 112 picks up the document.

The transfer roller 114 transfers the document supplied by the pickup roller 112. By providing a friction pad 115 proximal the transfer roller 114 to correspond to the pickup roller 112, the document sheet may be separated by the transfer roller 114.

The feeding roller 116 and the first backup roller 117 restricts a leading end E of the document advancing to an upper part of the reader part 160 to control a time point of transfer, thereby transferring the document in a well arranged state onto the ADF glass 150.

The discharge roller 118 and the second backup roller 119 discharge the document read by the reader part 160 to the document outlet 122.

A white bar 130 and a roller 140 are mounted on the document path P between the feeding roller 116 and the discharge roller 118. The white bar 130 is mounted above the ADF glass and supported by a resilient member 131, such as a spring, to bring the document into tight contact with the ADF glass 150. The roller 140 is mounted upstream of the white bar 130 in the document path P to substantially restrain vertical movement of the document. The roller 140 functions as a controlling member according to an exemplary embodiment of the present invention. The controlling member may also be implemented by a blade member. The white bar 130 is mounted to face the ADF glass 150, and the reader part 160 is mounted under the ADF glass 150.

The reader part 160 reads analog image information of the document and converts the read information to digital image information. For this, the reader part 160 includes a light source carriage (not shown) for receiving a light source that scans a light onto the document put on the ADF glass 150 and an image sensor, such as a charged coupled device (CCD) and a contact image sensor (CIS), for performing optical conversion in proportion to the light reflected from the document. A reference numeral A denotes a scanning position.

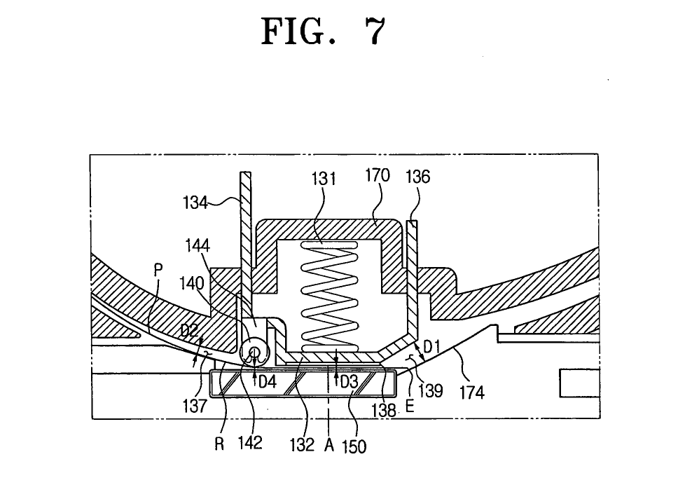

Referring to FIG. 7, the bottom 132 of the white bar 130 urges the document for tight contact with the ADF glass 150, such that the reader part 160 (FIG. 6) may read the image on the document. The white bar 130 has sidewalls 134 and 136 connected to the bottom 132, thereby having a substantially U-shaped section. A white sheet 138 is formed below the bottom 132 of the white bar 130. Above the bottom 132 of the white bar 130, the spring 131 elastically biases the white bar 130 to the ADF glass 150, being supported by a frame 170 to maintain tight contact between the ADF glass 150 and the document. A distance between the white bar 130 and the ADF glass 150 is maintained by projections (not shown) mounted on both ends of the white bar 130 at an interval greater than a width of the document, and the document passes between the projections (not shown).

A distance D3 between the white sheet 138 mounted below the bottom 132 of the white bar 130 and the ADF glass 150 is controlled to be approximately 0.5 mm. This maintains a minimal distance D3 because the reader part 160 reads fewer images from the document as the ADF glass 150 is distanced away from the document. However, if the distance D3 is too small, a paper jam may result. Therefore, the distance D3 is preferably about 0.5 mm.

On the document path P, a distance D2 refers to a width of a white bar entrance 137 which is a pathway for the document to enter the white bar 130 after passing through the roller 140. A distance D1 refers to a width of a white bar exit 139 which is a pathway for the document to exit the white bar 130 after passing by the scanning position ‘A’. The distance D2 is approximately 0.8˜1.0 mm, and the distance D1 is approximately 1.0˜2.0 mm. The distance D2 is preferably greater than the distance D3 to prevent a paper jam or slip of the document when the document enters under the white bar 130. The distance D1 is preferably greater than each of the distances D2 and D3 to prevent paper jams and resistance by the slope 174 when the document is discharged. Accordingly, resistance of the document, which may occur during the transfer of the document, is minimized.

The roller 140 is disposed upstream of the white bar 130 on the document path P between the feeding roller 116 and the white bar 130 to restrain vertical movement of the document entering under the white bar 130, thereby maintaining the constant distance between the document and the ADF glass 150. The roller 140 includes a rotation shaft 142 and a sponge material enclosing the rotation shaft 142.

The rotation shaft 142 of the roller 140 is connected to one sidewall 134 of the white bar 130 by a fixing member 144. The roller 140 is integrally formed with the one sidewall 134 of the white bar 130 in a length direction, that is, in a direction of the width of the document. At least one roller 140 is provided, and more may be used as necessary. By integrally forming the roller 140 with the white bar 130, the distance between the roller 140 and the ADF glass 150 may be constantly maintained. The roller 140 idly rotates by friction with the transferred document without being transmitted with a dedicated driving force. Since the roller 140 is made of a sponge material, the resistance applied to the document entering under the white bar 130 may be reduced, and further, lifespan of the roller 140 may be lengthened due to the high durability of the sponge material. The roller 140 is not limited to the sponge material but may be made of other materials capable of reducing the resistance applied to the document.

The distance D4 refers to an interval between the roller 140 and the ADF glass 150. Preferably, the distance D4 is approximately 0.2 mm˜0.3 mm, and is smaller than the distance D3, which is the interval between the bottom 132 of the white bar 130 and the ADF glass 150. By forming the distance D4 to be smaller than the distance D3, the rear part R of the document entering under the white bar 130 may be restrained from vertically fluctuating although the resistance occurs at the leading end E of the document by the slope 174 when the leading end E is exiting the white bar 130 after reading of the document at the scanning position ‘A’. Accordingly, the moving speed of the document may be uniform both at the leading end E and the rear part R. Since the front part F and the rear part R may move along the same document path P by substantially preventing vertical fluctuation of the document entering under the white bar 130, the speed of the document that passes through the scanning position ‘A’ may be uniformly maintained.

Hereinbelow, the operation of the ADF 100 having the above structure will be described with reference to FIGS. 6 to 9.

The document stacked on the document tray 120 is supplied to the document path P, and is passed through the pickup roller 112 and the transfer roller 114 The supplied document enters under the white bar 130 after passing through the feeding roller 116.

The document is passed between the roller 140 mounted at one sidewall 134 of the white bar 130 and the ADF glass 150, read by the reader part 160 at the scanning position ‘A’, and is discharged out of the white bar 130.

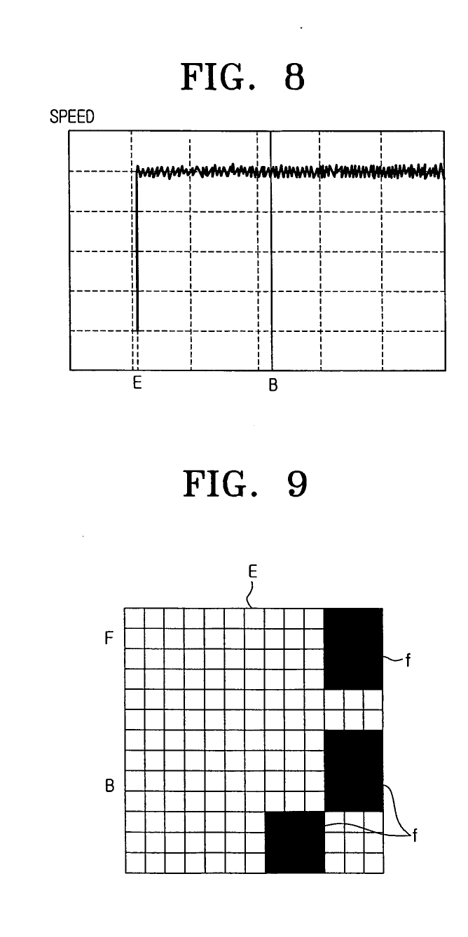

When the document is discharged, the leading end E is collided with the slope 174, thereby generating resistance. During this resistance, however, a space for the fluctuation of the rear part R of the document is minimized due to the roller 140 tightly biasing the document toward the ADF glass 150. Therefore, the rear part R of the document passes by the bottom 132 of the white bar 130 and the scanning position ‘A’ without causing a change in the moving speed compared to that of the leading end E. In the conventional image forming apparatus, the document path P is changed after the leading end E collides with the slope 174, thereby causing the difference of the moving speed between the leading end E and the rear part R of the document passing by the scanning position ‘A’. However, according to an exemplary embodiment of the present invention, change of the document path P does not occur before and after the leading end E collides with the slope 174, and therefore, the moving speed of the document passing by the scanning position ‘A’ may be constantly maintained. In FIG. 8, a horizontal axis refers to a length of the document divided by a certain interval, and a vertical axis refers to a speed of the document that is passing by the scanning position ‘A’. As shown in FIG. 8, the moving speed of the document passing by the scanning position ‘A’ is nearly uniform through the whole document. A minor change of the speed caused due to the resistance by the slope 174 is negligible.

FIG. 9 illustrates the document, as copied, passing through the scanning position ‘A’. Horizontal lines are scales dividing uniformly by 1 mm a printed letter ‘f’ of the document before scanning. As shown in FIG. 9, the printed letter is uniformly read through the scanning position ‘A’ because there is substantially no change of the document path P from the feeding roller 116 to the scanning position ‘A’.

As may be appreciated from the above description of the ADF and the image forming apparatus having the same, according to exemplary embodiments of the present invention, the document path P may be constantly maintained before and after the document passes through the white bar 130. Accordingly, the moving speed at the leading end E and the rear part R of the document may be substantially uniform while the document passes by the scanning position ‘A’, thereby improving the quality of the image that is copied or scanned.

Also, by integrally forming the roller 140 with one sidewall of the white bar 130, the distance between the roller 140 and the ADF glass 150 may be substantially constantly maintained. In addition, the sponge material for the roller 140 reduces the resistance during the transfer of the document and enables long lifespan.

While the invention has been shown and described with reference to certain embodiments thereof, it will be understood by those skilled in the art that various changes in form and details may be made therein without departing from the spirit and scope of the invention as defined by the appended claims.

What is claimed is:

1. An automatic document feeder (ADF) mounted above a reader part that reads a document to automatically supply the document to an ADF glass that supports the document, comprising:
a pickup roller for supplying a document;
a feeding roller for arranging and supplying the document;
a white bar disposed to face the ADF glass to bring the document into tight contact with the ADF glass; and
a controlling member mounted on a document path to substantially restrain vertical fluctuation of the document entering under the white bar.

2. The ADF of claim 1, wherein
the controlling member is implemented by at least one roller mounted upstream of the white bar of the document path.

3. The ADF of claim 2, wherein
a distance D4 between the ADF glass and the roller is smaller than a distance D3 between the ADF glass and a bottom of the white bar.

4. The ADF of claim 3, wherein
a distance D2 is a width of a white bar entrance that is a pathway for the document to enter the white bar, and a distance D1 is a width of a white bar exit that is a pathway for the document to exit the white bar, and the distances D1, D2 and D3 satisfy the relationship D3<D2<D1.

5. The ADF of claim 2, wherein
the at least one roller is integrally formed with the white bar.

6. The ADF of claim 5, wherein
the at least one roller is mounted in a length direction of the white bar.

7. The ADF of claim 5, wherein
the at least one roller idly rotates by friction with the document.

8. The ADF of claim 5, wherein
the at least one roller is rotatably connected to a fixing member fixed to one sidewall of the white bar.

9. The ADF of claim 8, wherein
the at least one roller has a rotation shaft rotatably connected to the fixing member and a sponge material that encloses the rotation shaft.

10. The ADF of claim 1, wherein
the controlling member is implemented by a blade member upstream of the white bar of the document path.

11. The ADF of claim 1, wherein
a resilient member biases the white bar toward the ADF glass.

12. The ADF of claim 11, wherein
the resilient member is a spring.

13. An image forming apparatus, comprising:
a cover having an automatic document feeder (ADF) and a document tray for stacking a document thereon;
a main body having a flat glass for leaf-scanning and an ADF glass for continuous scanning of documents supplied from the ADF disposed at an upper part of the main body, and a reader part mounted under the flat glass and the ADF glass;
a pickup roller for supplying the stacked documents;
a transfer roller for transferring the picked-up documents;
a feeding roller for arranging and supplying the transferred documents;
a white bar disposed to face the ADF glass to bring the document into tight contact with the ADF glass; and
a roller mounted on a document path to substantially restrain vertical fluctuation of the document entering under the white bar.

14. The image forming apparatus of claim 13, wherein
the roller is integrally formed with the white bar in a length direction of the white bar.

15. The image forming apparatus of claim 14, wherein
a rotation shaft of the roller is rotatably connected to a fixing member fixed to one sidewall of the white bar.

16. The image forming apparatus of claim 15, wherein
the roller has a rotation shaft rotatably connected to the fixing member and a sponge material enclosing the rotation shaft.

17. The image forming apparatus of claim 13, wherein
a resilient member biases the white bar toward the ADF glass.

18. The image forming apparatus of claim 17, wherein
the resilient member is a spring.

19. The image forming apparatus of claim 13, wherein
a distance D4 between the ADF glass and the roller is smaller than a distance D3 between the ADF glass and a bottom of the white bar.

20. The image forming apparatus of claim 19, wherein
a distance D2 is a width of a white bar entrance that is a pathway for the document to enter the white bar, and a distance D1 is a width of a white bar exit that is a pathway for the document to exit the white bar, and the distances D1, D2 and D3 satisfy the relationship D3<D2<D1.
